(19) United States
(12) Patent Application Publication
(10) Pub. No.: US 2011/0298147 A1
(43) Pub. Date: Dec. 8, 2011

(54) FORMING PLASTIC PANELS

(75) Inventors: Peter Aylmore, Riga (LV); Simon Wiper, Dilton Marsh Westbury (GB)

(73) Assignee: IPCO Ventures Limited

(21) Appl. No.: 12/960,028

(22) Filed: Dec. 3, 2010

(30) Foreign Application Priority Data
Mar. 25, 2010 (GB) GB 1005058.1

(51) Int. Cl. B32B 5/16

(52) U.S. Cl. 264/45.4

(57) ABSTRACT

A method of moulding articles from powdered material, comprising the steps of laying down at least two layers of powdered material of different granular fineness which include a heat mouldable material, in an open-topped mould, applying a top closure to the mould, and then heating the mould and the closure to melt and fuse the powdered material. In this way an article such as a building panel can be made to include recycled material, with three layers, including two outer skins of relatively fine-grained material, and an inner core including coarse-grained material such as ground-up waste.

### FIELD OF THE INVENTION

This invention relates to a method of forming a composite plastic panel or moulding from particulate material and fillers including suitable plastics and especially to a method which is useful for producing panels from a high proportion of recycled material.

### BACKGROUND OF THE INVENTION

There are a number of known processes for forming plastics materials into the required shapes for making relatively small articles, such as injection moulding, but such processes become progressively more unwieldy, and the associated equipment becomes much more expensive, when it is required to make relatively large panels such as building panels suitable for use as partitions, for example.

It is known to produce composite panels based on fibrous materials by forming a fibre layer or mat and then applying outer layers of expandable phenol resin and hot-pressing the assembly to consolidate it. Such a method of forming boards is described in U.S. Pat. No. 4,734,231 (Morita et al). JP2003112329 discloses a similar kind of board comprising a core of mixed carbon material and phenol resin powder, and a surface material comprising mixed solid phenol resin and chaff or straw, which is formed by compressing the mixtures and heating to cross-link the phenol resin. However, panels including such fibrous materials may not be sufficiently dense or strong for general building or construction purposes, and it is also difficult to achieve a smooth finish on the outer surface.

Furthermore if it is desired to utilise ground-up recycled waste material (for example) to make a more solid core, it is difficult to make a strong integral structure without employing a multi-stage process in which the core material is first combined with a binding material. This is because the thermoplastic material of the outer layer may not penetrate the core layer sufficiently to bind it together.

It is also known to make structural panels from moulded material, by separately forming relatively thin panels from a first, more fine grained material so as to provide a relatively well finished “skin”, and then arranging a pair of the relatively thin panels in a suitable mould or former, with a space between them in which another plastics material is formed into a foam, so as to provide a composite structure which is relatively strong, and may also be relatively coarse grained or contain a large volume of voids, so as to provide the resulting composite structure with good insulating qualities.

As an alternative to plastics or moulded materials for the external skins, of course, sheets of metal or other suitable sheet material may be utilised, but in any case the formation of such panels by conventional methods tends to involve a relatively slow and cumbersome multi-stage process, because of the necessity to pre-form some components and then to manipulate them into the required arrangement for forming the final structure. Where it is required to manufacture relatively large structural panels, for instance, sizes such as 2.4 m×1.2 m, it is consequently expensive to automate such known systems because of the need for complex handling equipment.

### BRIEF SUMMARY OF THE INVENTION

Accordingly the present invention provides a method of moulding articles from heat mouldable powdered material, comprising the steps of laying down at least two layers of material of different granular fineness in an open-topped mould, at least one of the layers including heat mouldable material, applying a top closure to the mould, and then heating the mould and the closure to melt and fuse the powdered material.

The layers of powdered material may be laid down in the mould by means of a known type of powder distributor comprising a trough which can be traversed over the mould, and has a dispensing roller arranged in the base which can be rotated at a suitable speed to control the dispensing rate.

In a typical embodiment, at least the coarser one of the layers includes a foaming agent which is heat or chemically-activated, so that the structure expands in the closed mould to form a rigid composite article. Preferably where there is one other layer of finer material, that layer includes a thermoplastic material so that application of heat to the mould while it is closed, assists in fusing or bonding the article together. Thus in a preferred form of the invention, there is a coarse-grained layer of material which may advantageously include ground-up, recycled waste material, mixed with a foaming agent, and a finer-grained layer which comprises or includes thermoplastic material which forms a smooth outer skin. Preferably, there are three layers, with both of the outer layers including thermoplastic material so that the article is formed with a relatively smooth skin on both sides.

A preferred form of the present invention provides a method for moulding panels having a relatively fine external finish, and a relatively coarse “core” structure which may include ground-up recycled materials, comprising the steps of:

(a) laying down a layer of first, fine grained, heat mouldable material in a lower mould half to form a lower layer;

(b) laying down a further layer of relatively coarse material to form a central layer;

(c) laying down a further layer of fine grained heat mouldable material, on top of the core material, to form an upper layer;

(d) moving the upper and/or lower mould so that the upper mould contacts the upper surface of the upper layer, so as to enclose the layers of material in the lower mould; and

(e) applying heat to the moulds, so as to fuse the outer layers of material to form an external skin, whilst the central layer is foamed so that it expands and fuses with the two outer skin layers, and the outer surfaces of the two skin layers are moulded into close contact with the base of the lower mould half and the underneath surface of the upper mould.

Preferably, the central layer includes a heat-activated or chemically-activated foaming agent.

It will be appreciated that heat may be applied to the moulds in advance of the addition of the moulding materials, and/or while they are being added, as well as after the moulds are closed.

In one embodiment of the invention, the layers of powder are laid down by means of a multi-compartment tray distributor having a roller type dispensing mechanism at the base of each compartment, which is arranged to traverse across the mould or moulds and adapted to distribute powder at controlled rates as it moves. Depending on the specific arrangement of layers and process stages, the tray may be arranged to distribute one or more layers in each pass.

In one example of the process, after the foaming agent has been activated the top-plate is gradually retracted by a predetermined distance, whilst maintaining contact with the product, to allow the panel to expand to a suitable thickness. In this way it is possible to produce a range of panel thicknesses using the same quantity of fill material, or different quantities to achieve different densities, by retracting the top plates by different distances. Normally this is done in a controlled fashion for example by means of hydraulic or pneumatic actuators with feedback control. Alternatively in a simplified form of the process, it may be achieved by means of a top closure for the mould which is suitably weighted relative to the strength of the foaming agent.

In one embodiment, the finer grained powder is in the range of 100 to 3000 μm, most preferably 500 to 1000 μm, and may include thermoplastic material such as polyethylene, whilst the coarser grained powder may include various kinds of suitable granular filler made by grinding a variety of recycled materials, and may have a granule size of up to 10 mm. Typically, in order to form 18 mm (¾ inch) building boards, the external skin layers may be 1 to 1½ mm thick, so that the internal core is approximately 15 mm thick, and panels may, for example, be made in a similar way, up to 30 mm thick, with the same outer skin thickness. However for special applications the external skin layers may be anywhere between ½ mm and 7 mm thick while the panel may have a total thickness of up to 10 cm.

In a preferred form of the method according to the invention, the powder is added to the mould, while still at least at ambient temperature, and the temperature is raised to a temperature of up to 350° C., but typically between 190° and 220° after the mould has been closed, and held there for a length of time which depends on the thickness and density of the resulting product but is usually in the range of 5 to 40 minutes. In a typical case it will be 10 to 20 minutes. Preferably, heat is applied by means of fluid passages in the material of the moulds which may be made from a relatively easily workable material such as aluminium, since the temperature and pressure involved in the process are not particularly high. However, if the materials used for the process include particularly corrosive substances, the moulds may be made from more resistant materials such as pyrex glass or ceramic. As an alternative to fluid heating, electric resistance, inductive, or microwave heating may be employed.

It will be appreciated, however, that because of the pressure generated by any foaming agent, which is included, the moulds must be rigidly supported, and the upper mould also requires a suitable mechanism behind it, such as an arrangement of pneumatic or hydraulic rams, to hold it in position during the process.

It will also be appreciated that because of the relatively simple method of distributing the powders into the lower mould, the process is able to utilise a wide range of recycled material, including paper, cardboard, rubber, plastics and metal, fibres and minerals, so long as it is of a suitable size, although preferably, a proportion of suitable thermoplastic material is included, especially in the outer skin layers, so as to fuse the material into a unitary structure.

Additional material can also be included such as glass or carbon fibre, reinforcement steel mesh or organic fibre such as bamboo or banana fibre as well as material intended to add specific properties such as fire-retardant or anti-ballistic material.

In a preferred method according to the invention, a plurality of tray-shaped lower moulds are arranged in an array and a corresponding array of upper moulds are arranged to be movable into a position above the filled lower moulds to be lowered into engagement with them, to form panels using the steps of the method set out above, and the formed panels can then be removed from the lower moulds which are then refilled so as to enable a continuous production process to be achieved.

### BRIEF DESCRIPTION OF THE SEVERAL VIEWS OF THE DRAWINGS

One embodiment of the invention will now be described by way of example with reference to the accompanying drawings which show some suitable arrangements of panel forming equipment, in a succession of forming steps as follows:

FIG. 1 shows a first arrangement comprising two sets of moulds “A” and “B”, each consisting of an array of four female formers or trays 2, 4, (making eight lower moulds) and corresponding array of four male moulds 6, 8 (making eight upper moulds);

FIGS. 2-18 illustrate successive steps in the forming process for the arrangement of FIG. 1;

FIGS. 19-34 illustrate corresponding steps utilising an alternative arrangement including a total of sixteen female formers to optimise the use of the other equipment as explained in more detail below;

FIG. 35 is a diagrammatic cross-section through a powder distribution device; and

FIG. 36 is a diagrammatic cross-section through a single-mould arrangement.

### DETAILED DESCRIPTION OF THE INVENTION

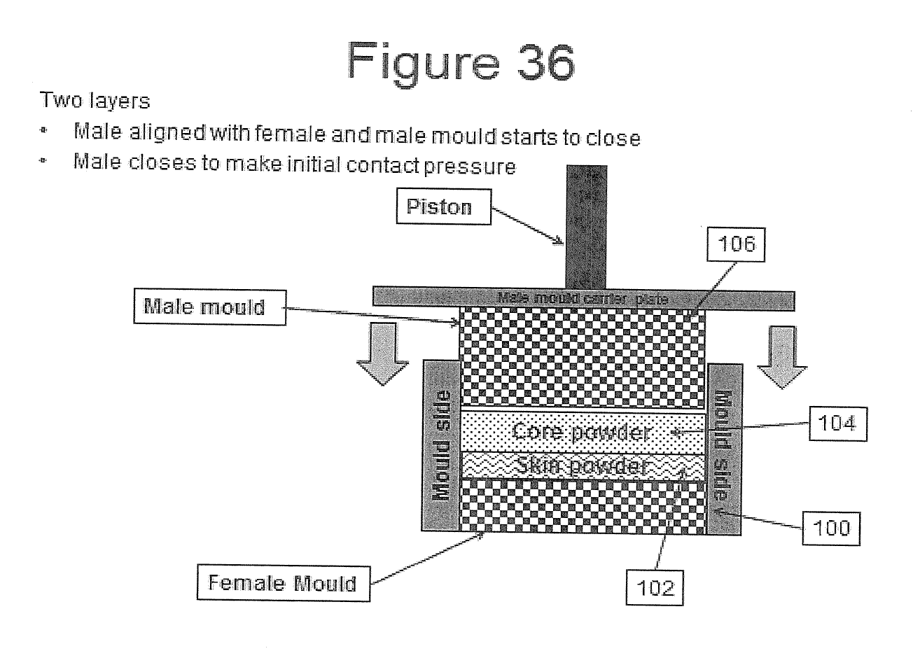

In the detailed example of the invention that follows, a system is described which is capable of producing multiple sets of moulded articles simultaneously by means of corresponding sets of moulds. However, it will be appreciated that a simplified form of the process could utilise a single mould. FIG. 36 illustrates the basic principle of the invention utilising a single female mould 100 into which successive layers 102, 104 of different powdered materials have been laid down. A male mould half is then lowered into contact with the top layer 104 which comprises relatively fine-grained thermoplastic material, and heat is applied to melt the layer. The coarser grained material of the lower layer 102 may include a foaming agent which is also heat-activated, and thus the lower layer expands so that the two layers become compressed between the mould halves forming a rigid composite panel. The upper mould half 106 may then be allowed to retract slightly in response to the pressure, to allow the panel to reach a predetermined thickness.

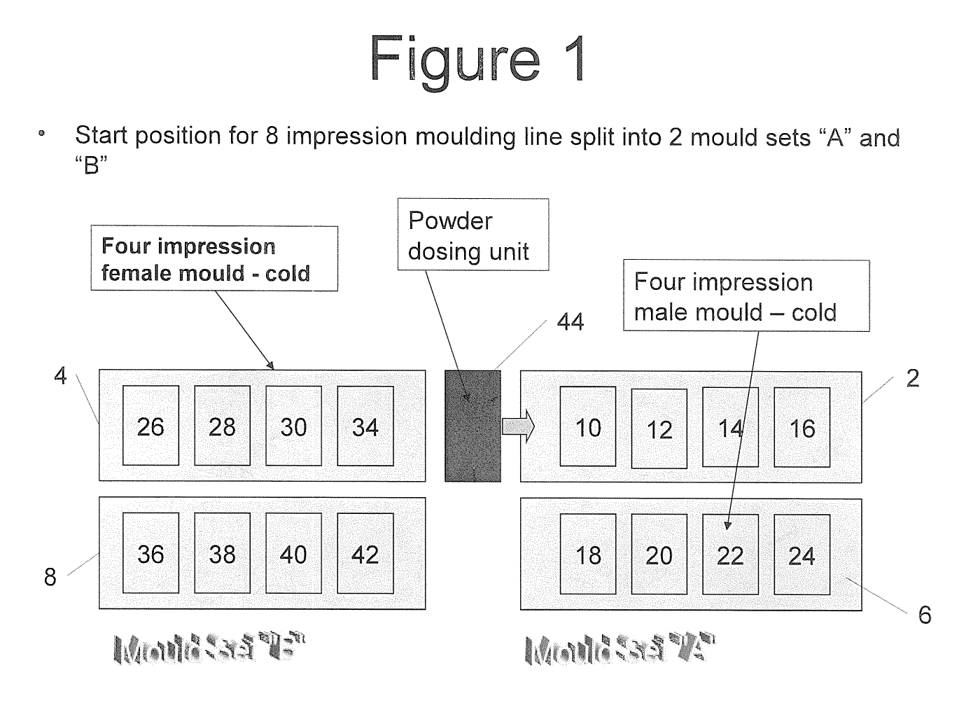

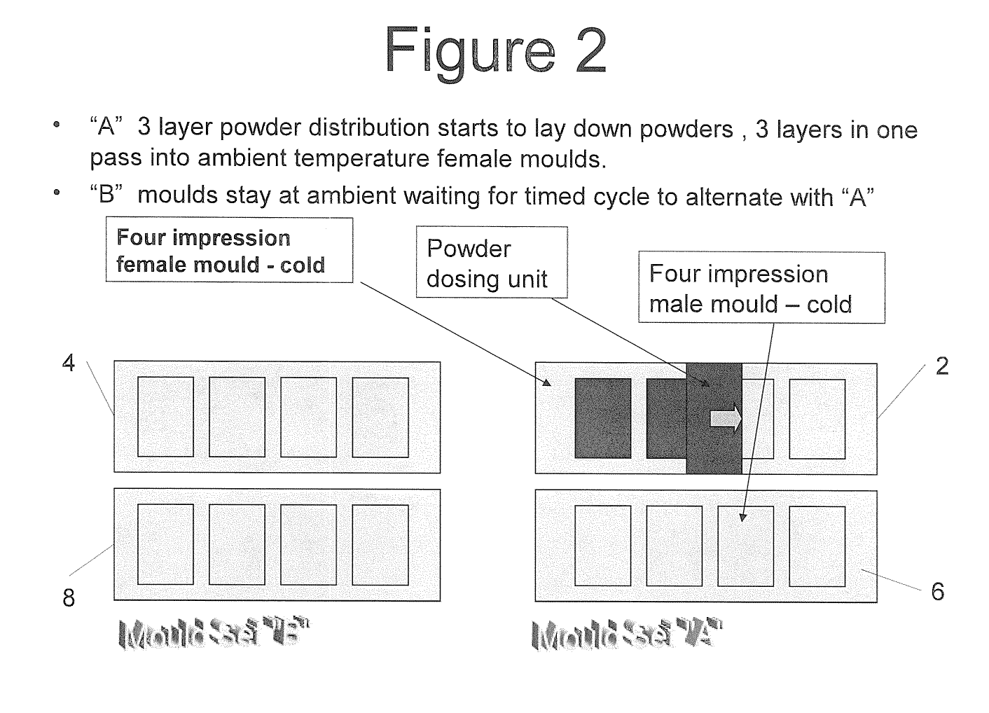

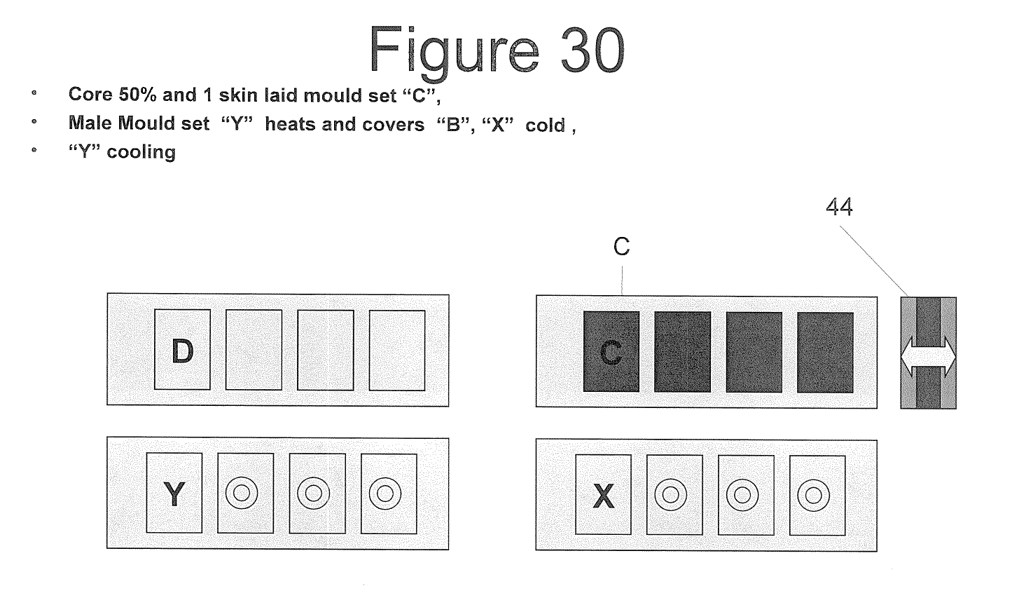

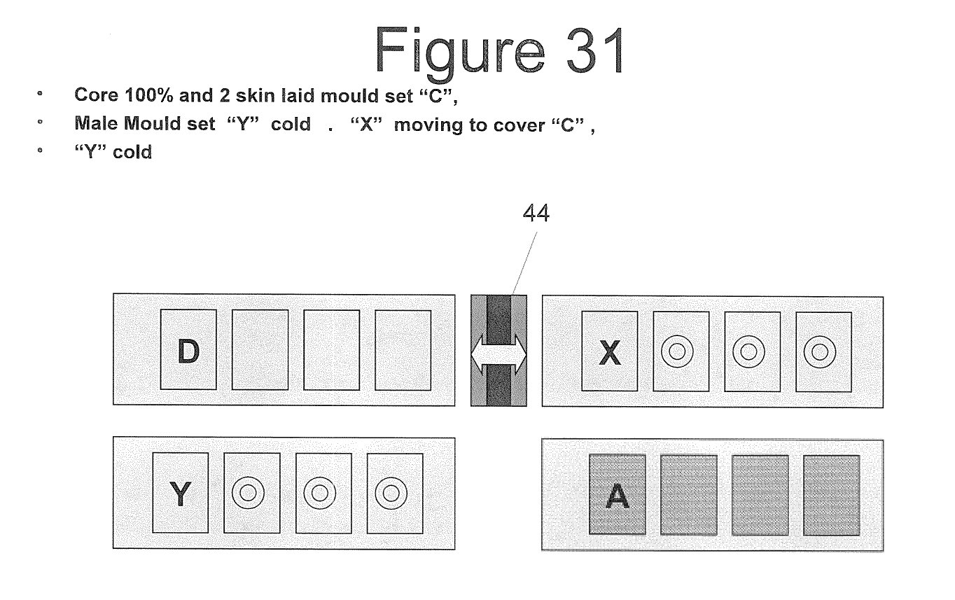

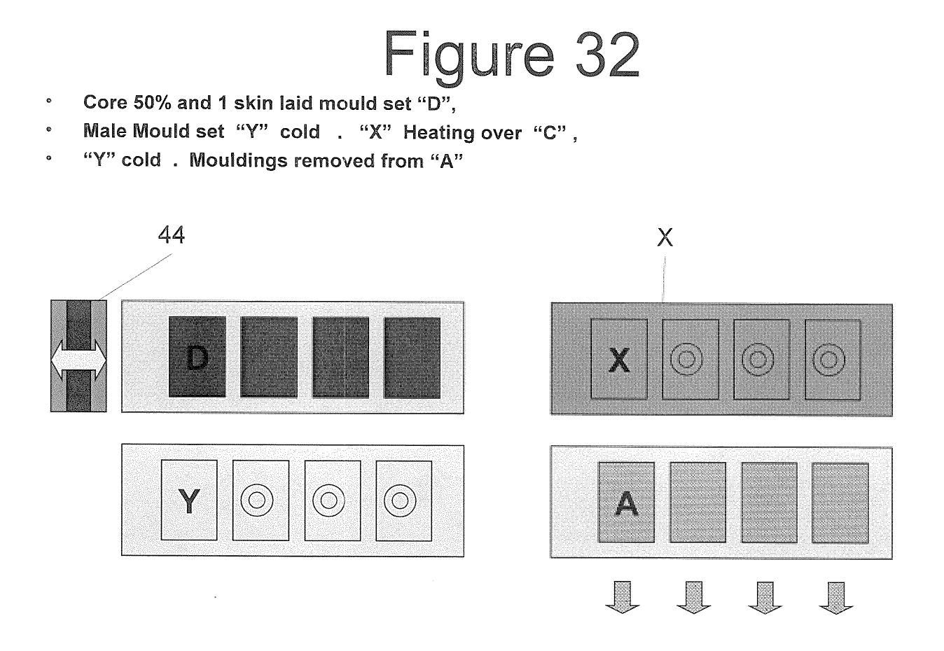

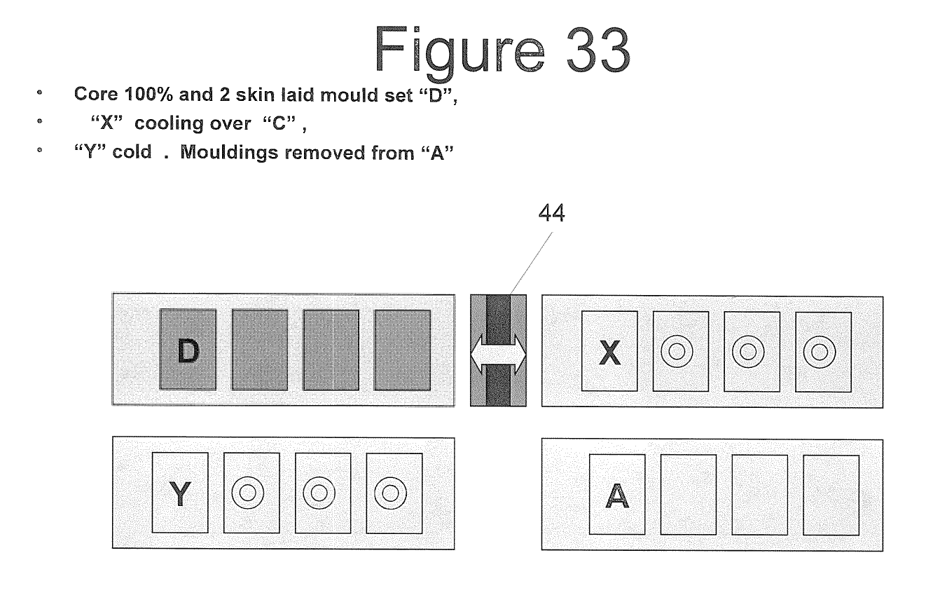

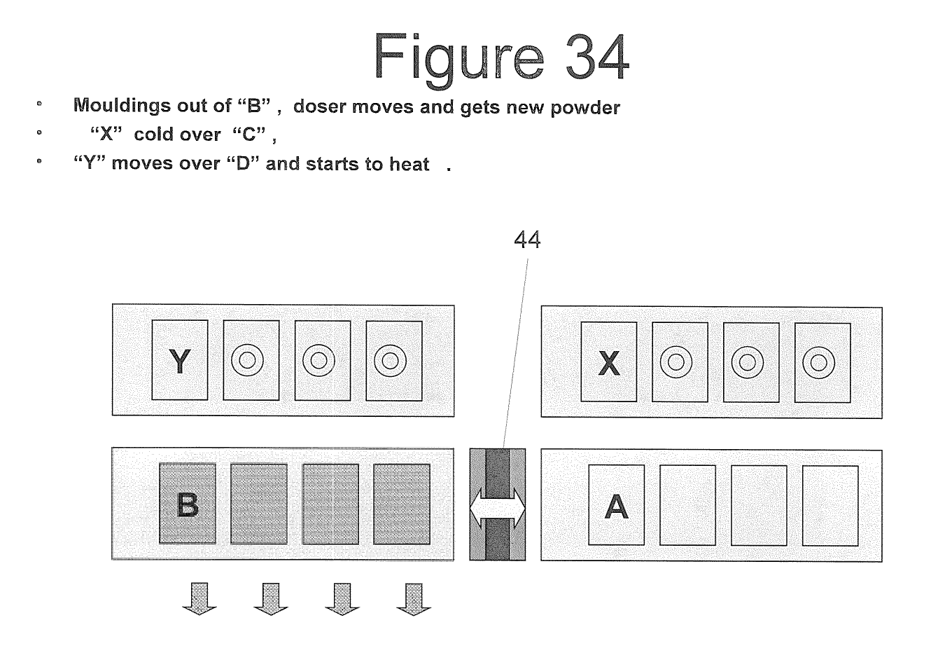

FIGS. 1-35 illustrate in more detail, a system for producing panels in batches, rather than singly. FIG. 1 shows an arrangement including of a first mould set “A” which comprises a rectangular female mould 2 including four female formers or trays 10, 12, 14, 16, and a male mould including four corresponding rectangular lands or projections 18, 20, 22, 24 which are sized to fit into the openings of female trays 10-16. Similarly a second mould set “B” comprises four female formers or trays 26-34 and four corresponding male projections 36-42.

Female mould sets 2 and 4 are arranged beneath corresponding sets of vertically movable actuators, not shown, which are used as explained in more detail below, for bringing the corresponding male mould sets 6, and 8, into engagement with them in the course of the moulding process. A powder dosing unit 44, comprising a compartmented tray for moulding powders is arranged on a suitable support track so that it can traverse across the female mould sets 2 and 4.

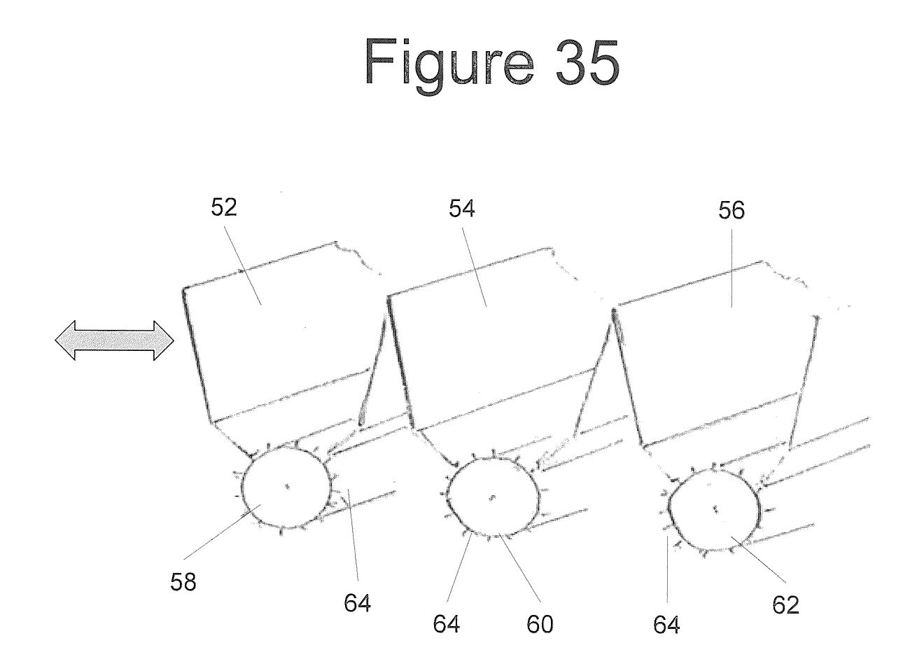

At the start of the process (FIG. 1), all the moulds start at least at ambient temperature, and the powder dosing unit is traversed across the female moulds 2 of mould set “A”. The dosing unit has three laterally-extending compartments as described below, with reference to FIG. 35, the leading compartment dispensing a first, relatively fine powder to form the lower surface of the moulding, the middle compartment dispensing a relatively coarse powder, including a blowing agent to form the core, and finally the trailing compartment being arranged to dispense a further fine layer to form the upper surface.

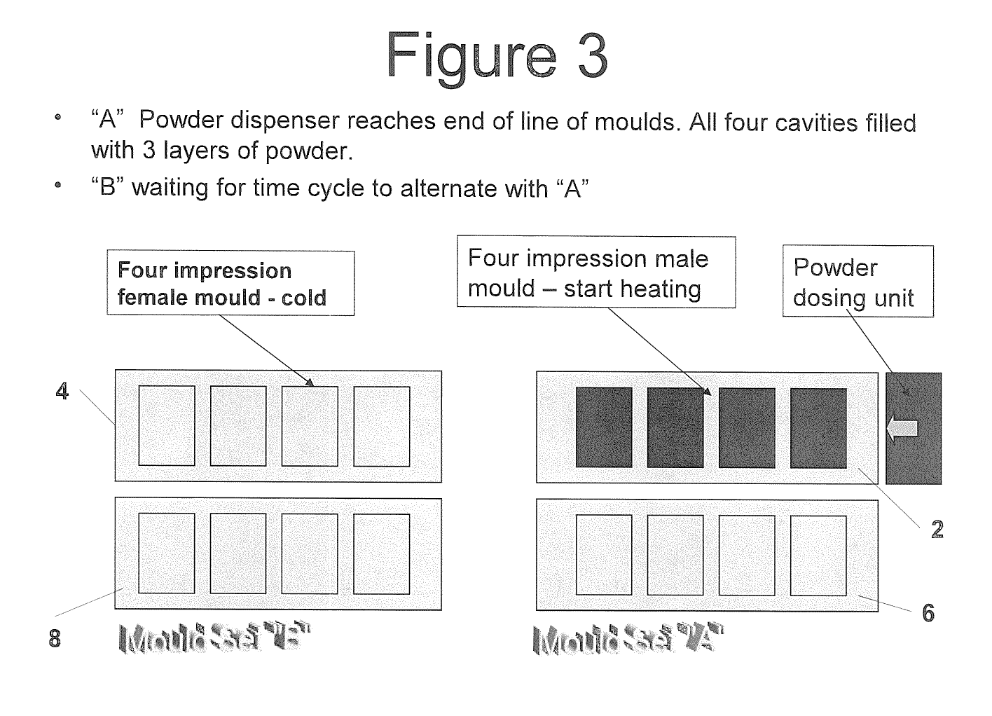

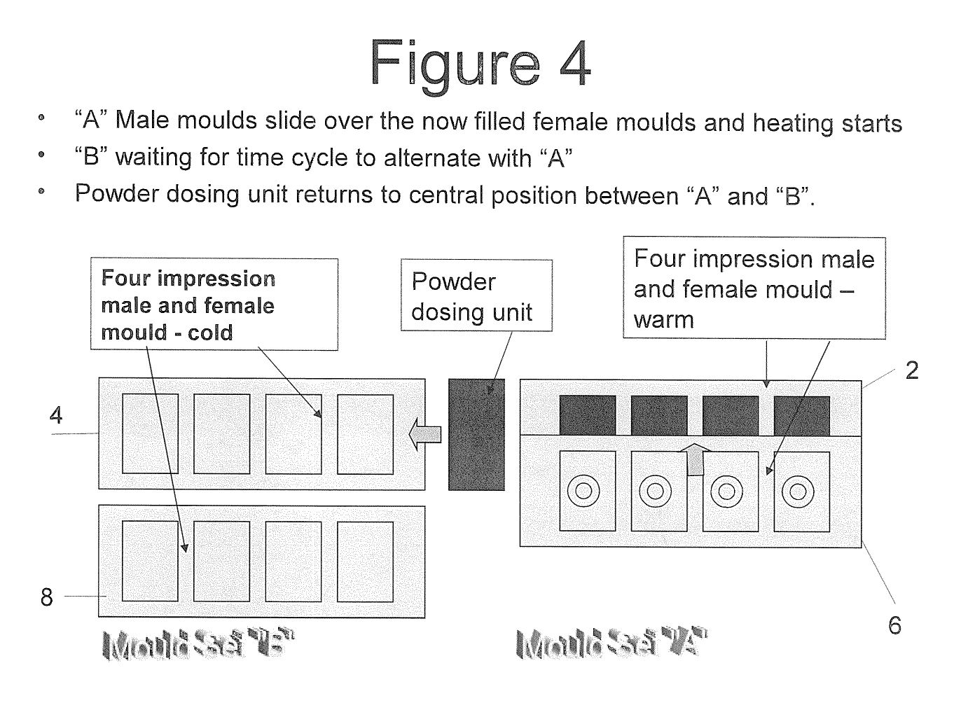

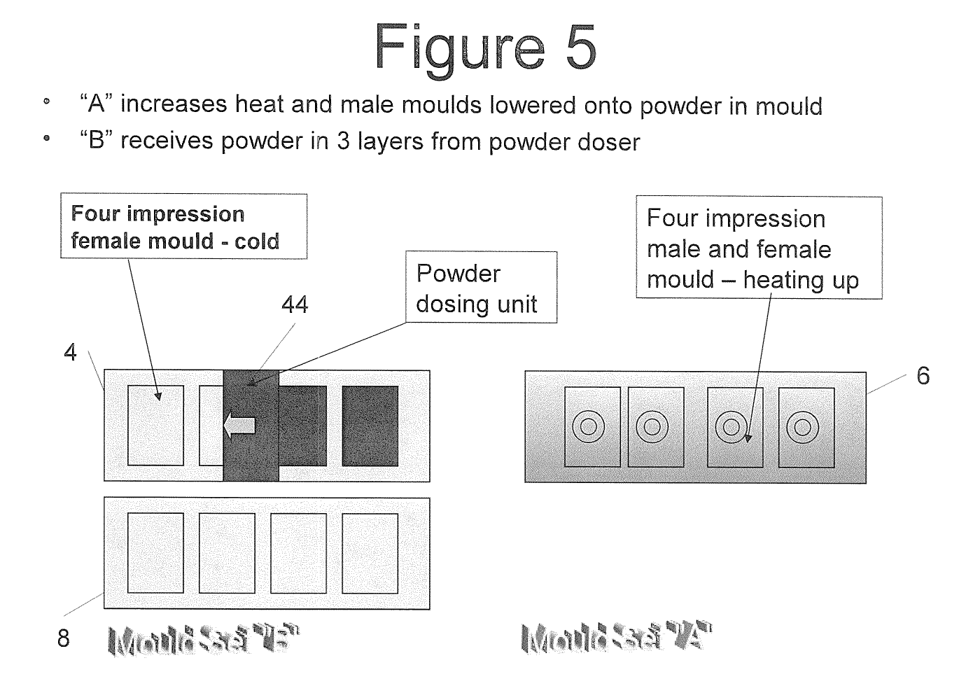

Once the female mould 2 of mould set “A” is filled, heating of the male and female moulds begins (FIG. 3) and the “A” male moulds begin to move laterally to a position where they are superposed over the female moulds (FIG. 4). Once they are in position (FIG. 5) the male moulds are lowered into engagement with the female moulds and heating continues while the powder dosing unit 44 is traversed to the position of the mould set “B” where it dispenses powder into the trays 26-34 of the female mould 4 of the mould set B.

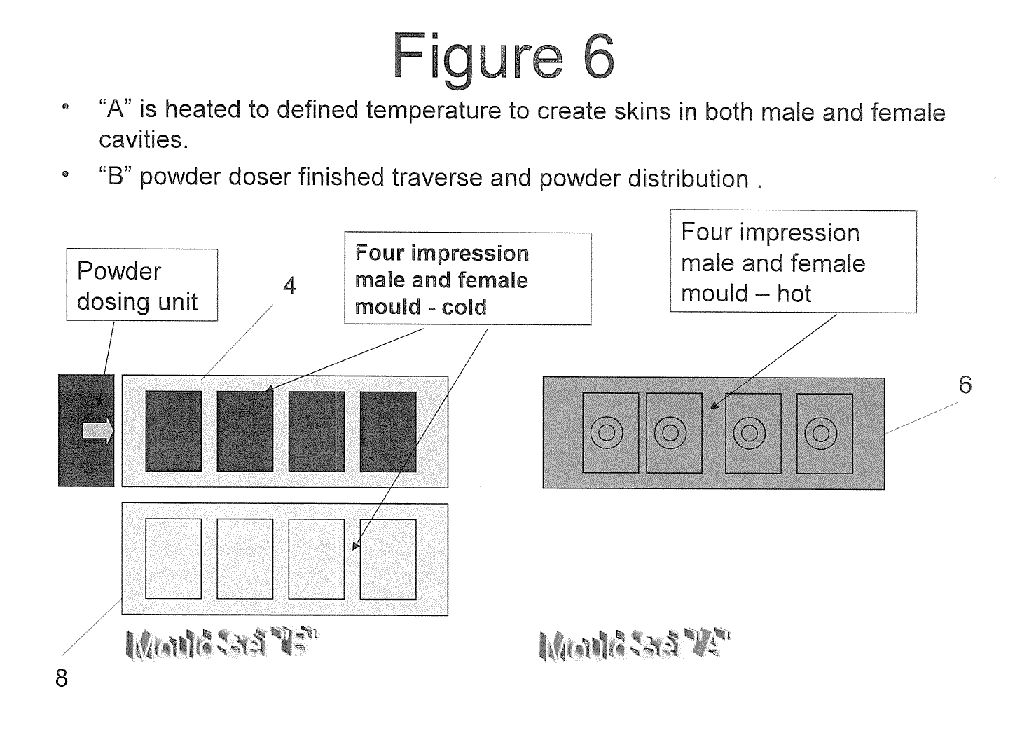

FIG. 6 shows the next stage where the powder dosing unit 44 has completed its traverse of female mould 4 and in the meantime the temperature of the heaters of mould set “A” is raised to a level which is sufficient to create skins on both the upper and lower surfaces of the powder bodies in the four moulds.

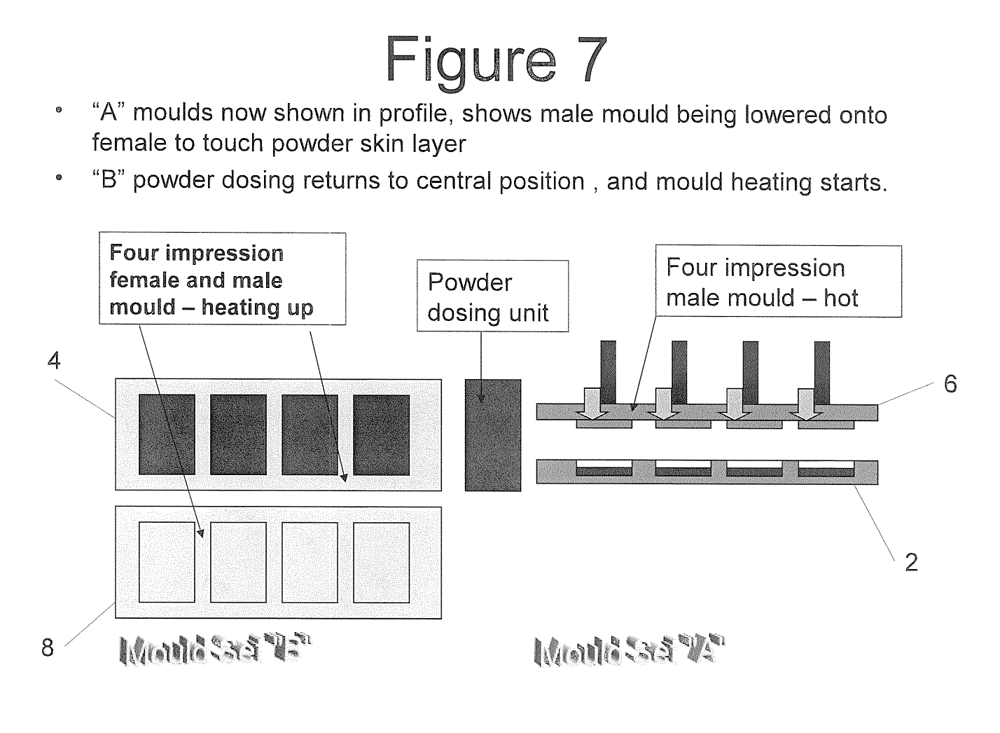

In FIG. 7 the “A” moulds are shown in elevation rather than plan to illustrate the vertical movement of the heated male mould 6 as it is lowered onto the female mould 2, to touch the powder surface and melt it to form the upper surface skin. In the meantime of course, mould set B is still in the process of heating up.

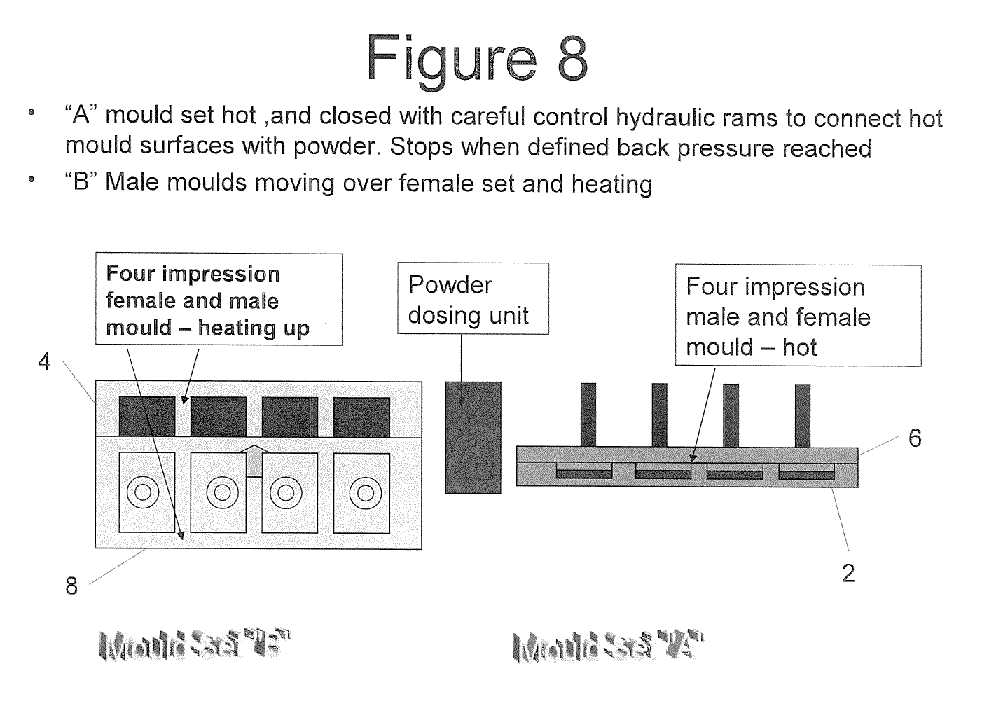

In FIG. 8, mould set “A” is closed, the actuators being carefully controlled to a precise vertical position to contact the hot male mould surface with the powder, for example by feedback control in accordance with the back pressure. At the same time the male moulds 8 of mould set B are being shifted towards the engagement position above their corresponding female moulds 4, while moulds 4 and 8 are both heating up.

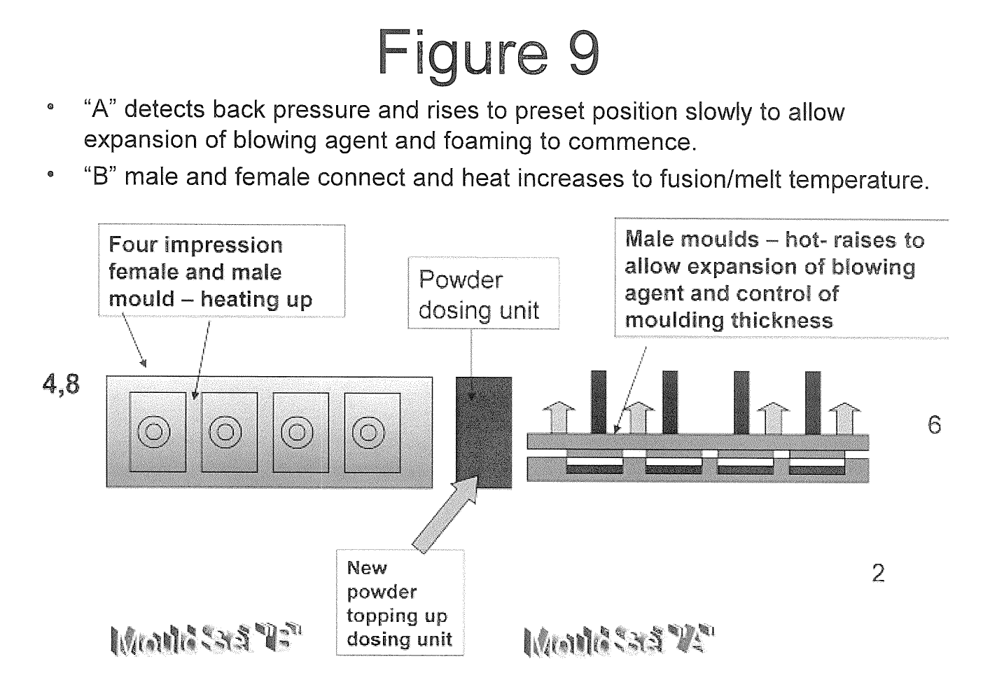

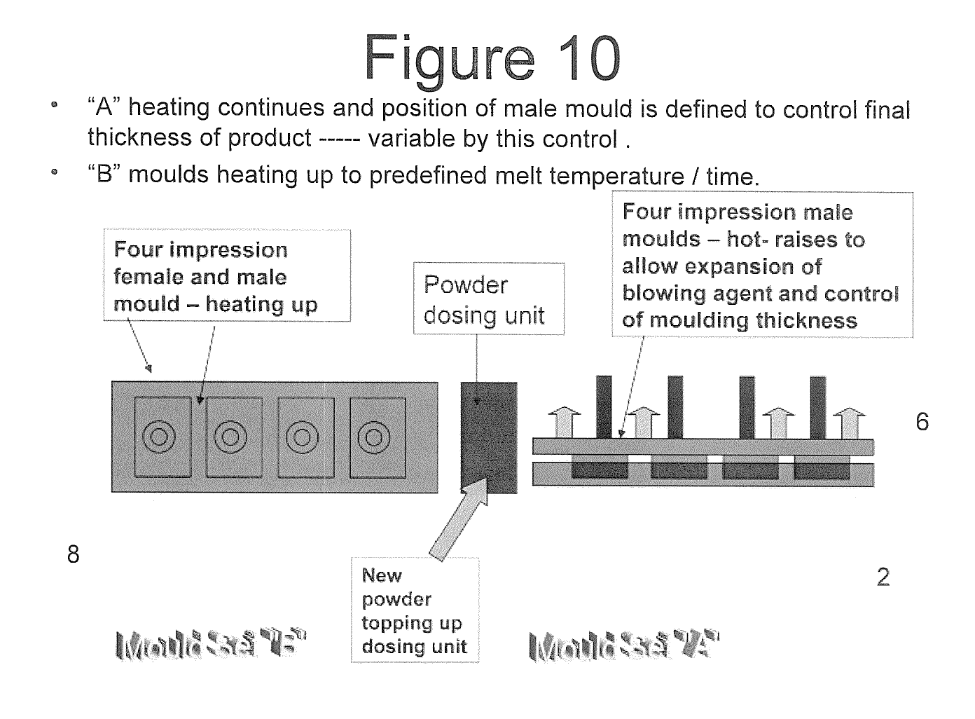

FIGS. 9 and 10 show the stage of the process where the material in mould set A has reached the point where the blowing agent of the core is activated, and when the resulting increase in back pressure is detected, male mould set 6 is retracted to allow expansion towards a preset position which defines the intended thickness of the moulded panel, which is achieved by foaming of the blowing agent. At the same time, male and female mould halves “B” are closed together, while continuing to heat up. The powder dosing unit which has returned to the central position, is now being topped up ready for the next powder dispensing cycle.

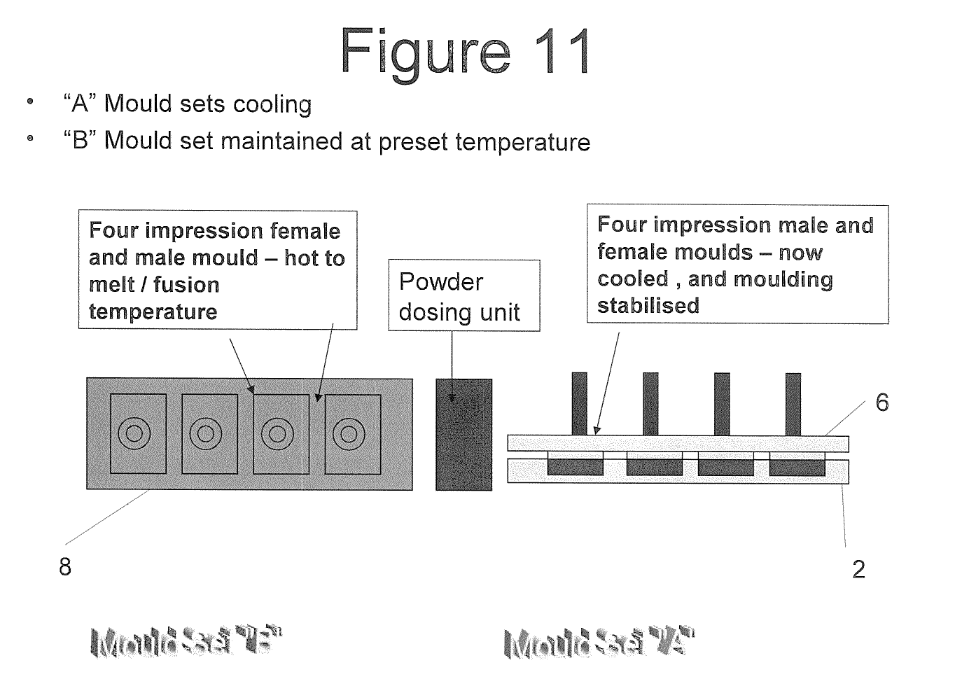

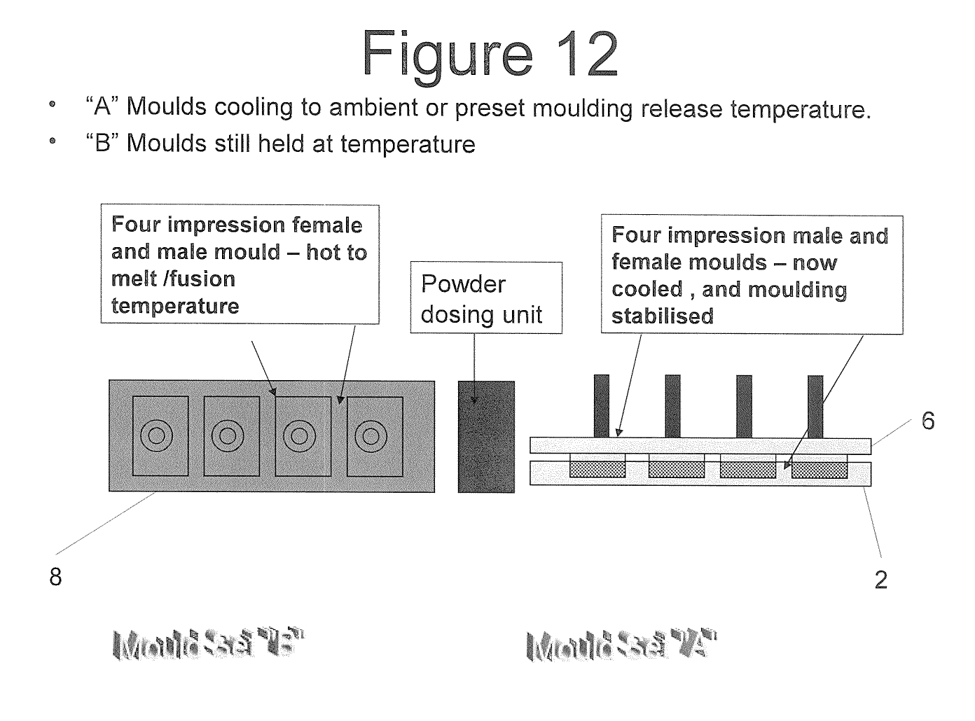

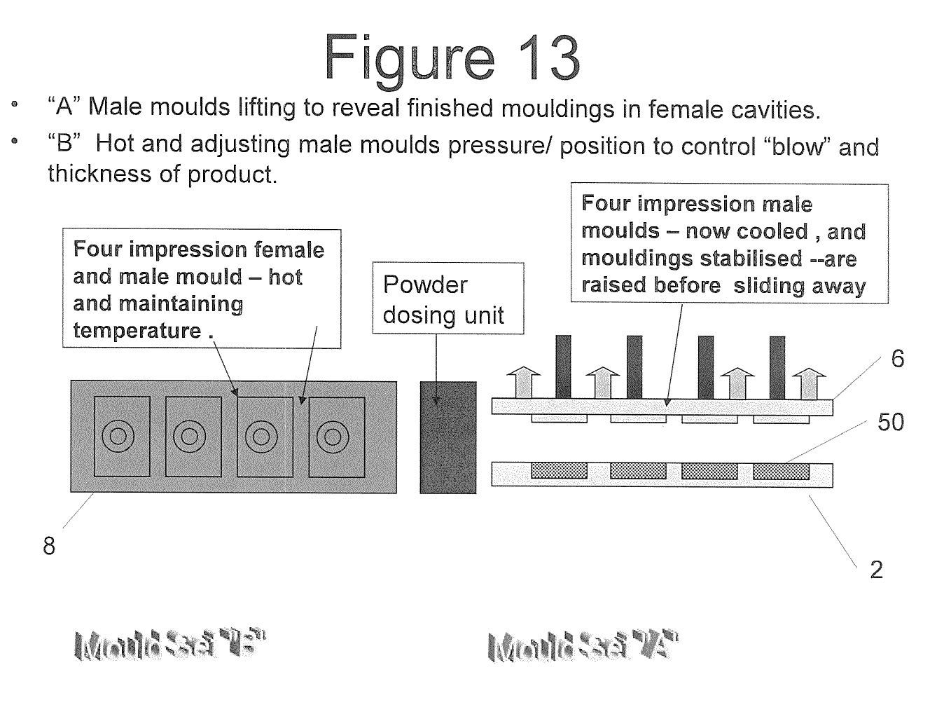

The drawings at FIGS. 11-12 show the final stages of forming the panels in mould set “A” where the moulds are cooled and the mouldings are stabilised, while mould set “B” is reaching the melt/fusion temperature. Cooling of moulds “A” continues until they reach ambient or a preset moulding release temperature, whilst in FIG. 13 the male moulds of set “A” are raised to reveal the finished mouldings 50. In the meantime, the mould set “B” has reached the stage of adjusting the male mould vertical position to control the expansion of the mouldings i.e. corresponding to the FIGS. 9-10 stages described above in respect of mould set “A”.

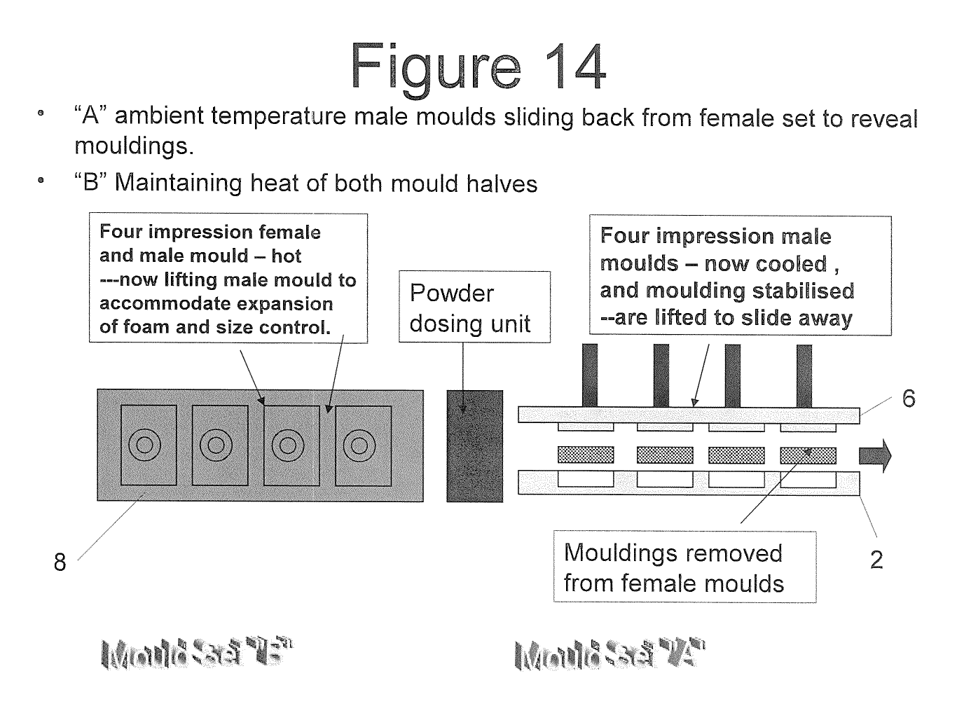

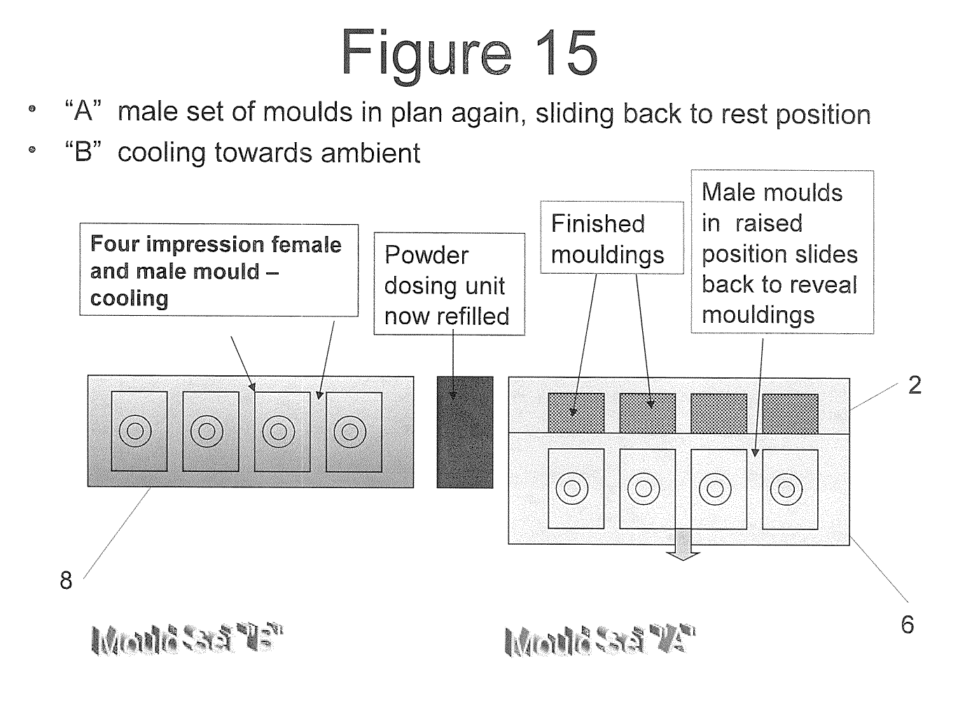

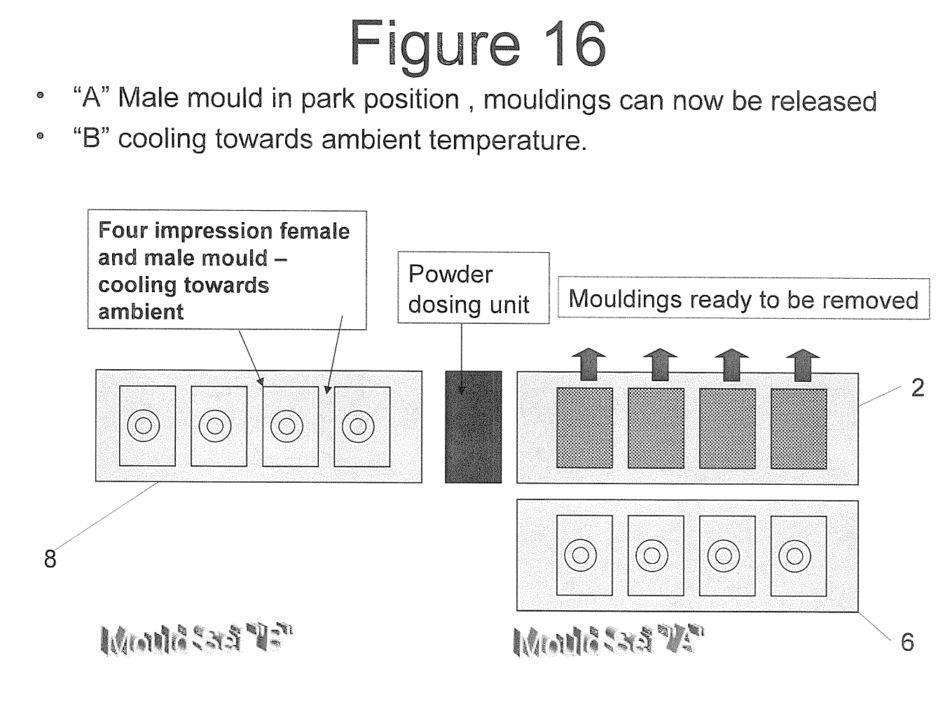

In FIG. 14, the stabilised mouldings 50 are removed from mould set “A” while the vertical position adjustment continues in mould set “B” so as to accommodate the foam expansion and control resulting panel thickness, while in FIGS. 15 and 16 plan views of mould set “A” are again illustrated to show the male moulds “A” being retracted to their original lateral position to allow access to the finished panels in the female mould trays. At this stage the panels in mould set “B” are cooling and the powder dosing unit has been refilled.

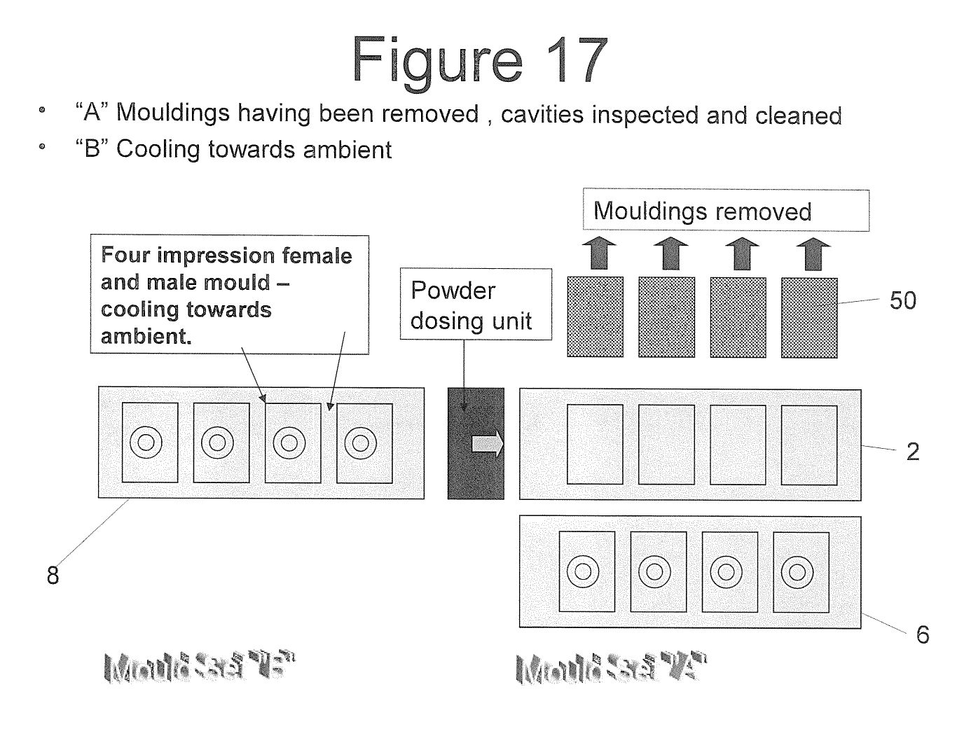

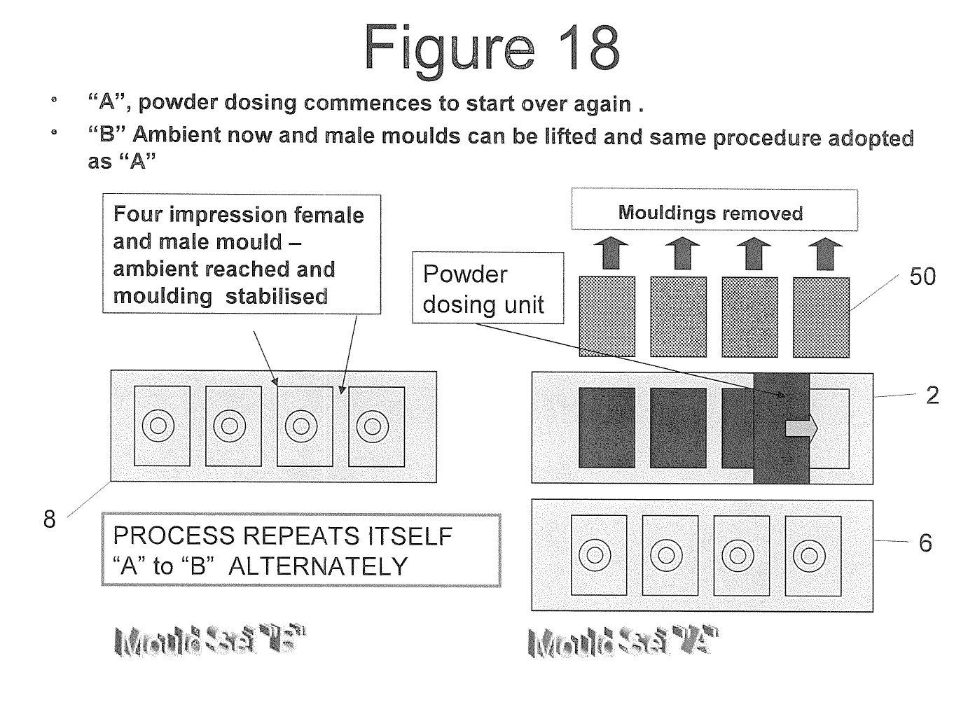

In FIG. 17, the moulded panels have been removed from mould set “A” so that the cavities can be inspected and cleaned, while in FIG. 18, the powder dosing unit is shown beginning another traverse of the female mould 2 of mould set “A” to begin the cycle again. At the same time, mould set “B” has now cooled to ambient temperature ready for the male moulds to be lifted clear, so that the completed panels can be removed.

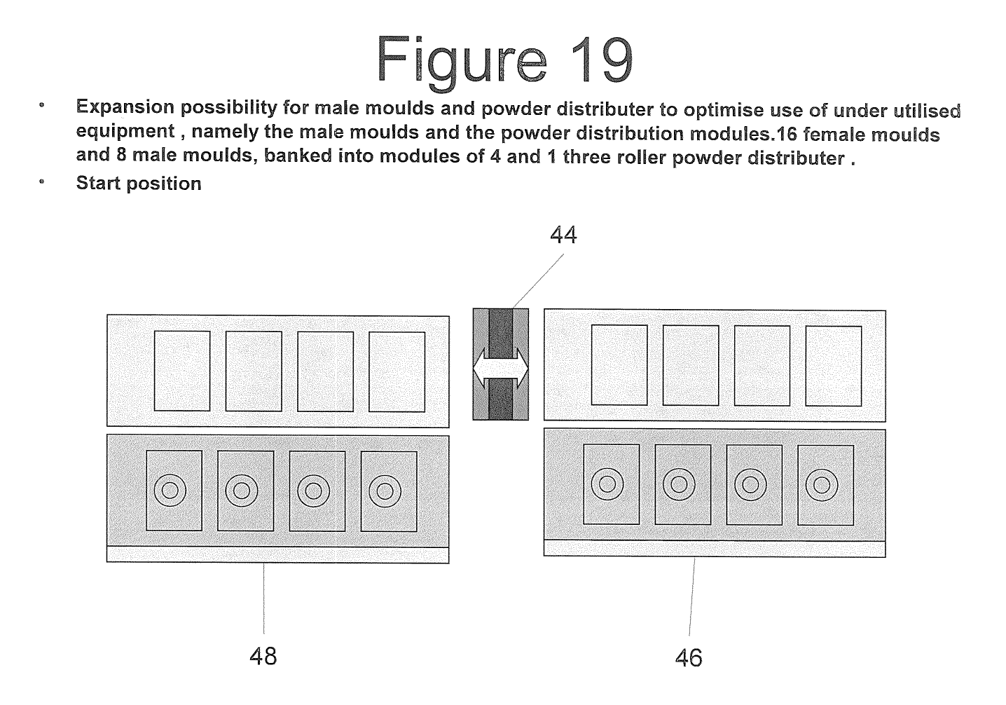

Referring to FIG. 19, this shows an arrangement in which includes an additional female mould 46, 48 in each set (corresponding to sets “A” and “B” in FIGS. 1-18) so that the “set” comprises a single male mould which can traverse between the positions of two adjacent female moulds, allowing more optimal use of the equipment. Accordingly, as shown in the figures, each “set” includes female mould trays, for 8 panels, and male moulds for 4 panels so that a total of 16 panels can be in different stages of foaming at the same time.

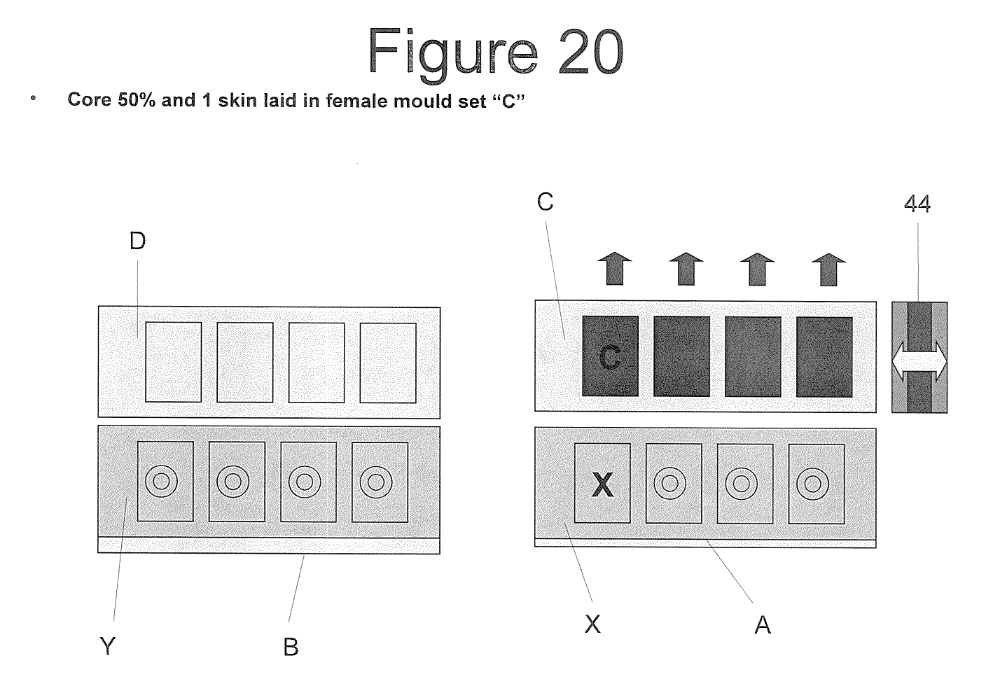

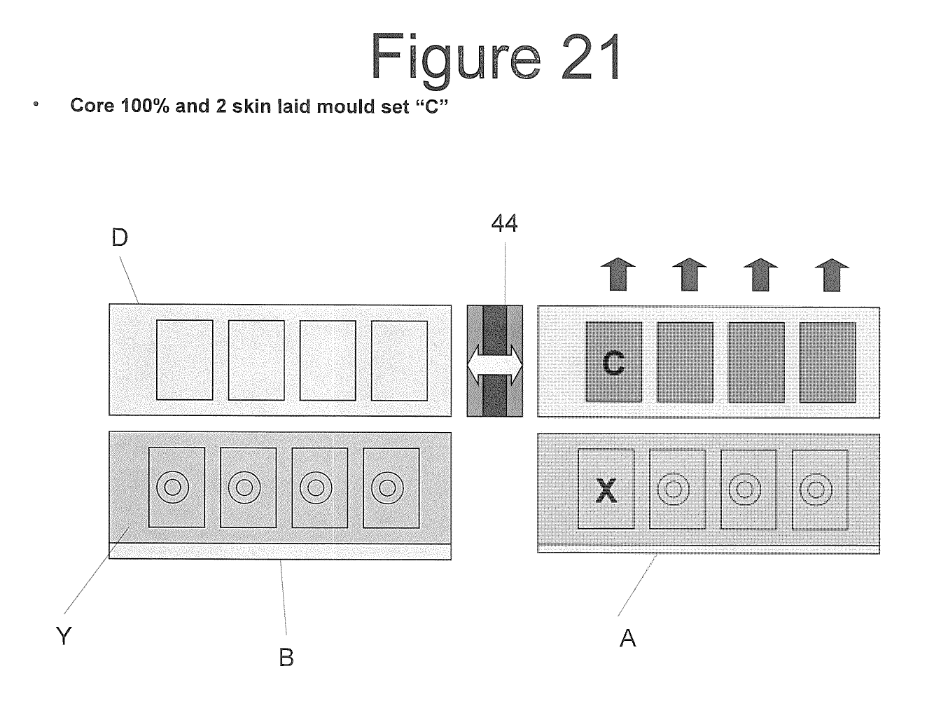

In this and the succeeding figures, the adjacent female moulds of one set are shown as “A” and “C”, with the male moulding being shown as “X”. Similarly the female moulds of the other set are shown as “B” and “D” and the male mould as “Y”, as indicated in FIG. 20. This figure illustrates how the first pass of the dosing unit (44) is used to fill female mould “C” so that the first (lower) layer of fine powder material, and 50% of the core material are laid down, and then on the return pass (FIG. 21) the other 50% of core material and the second (top) layer of fine material are added so that the dosing unit is traversed back to the central position.

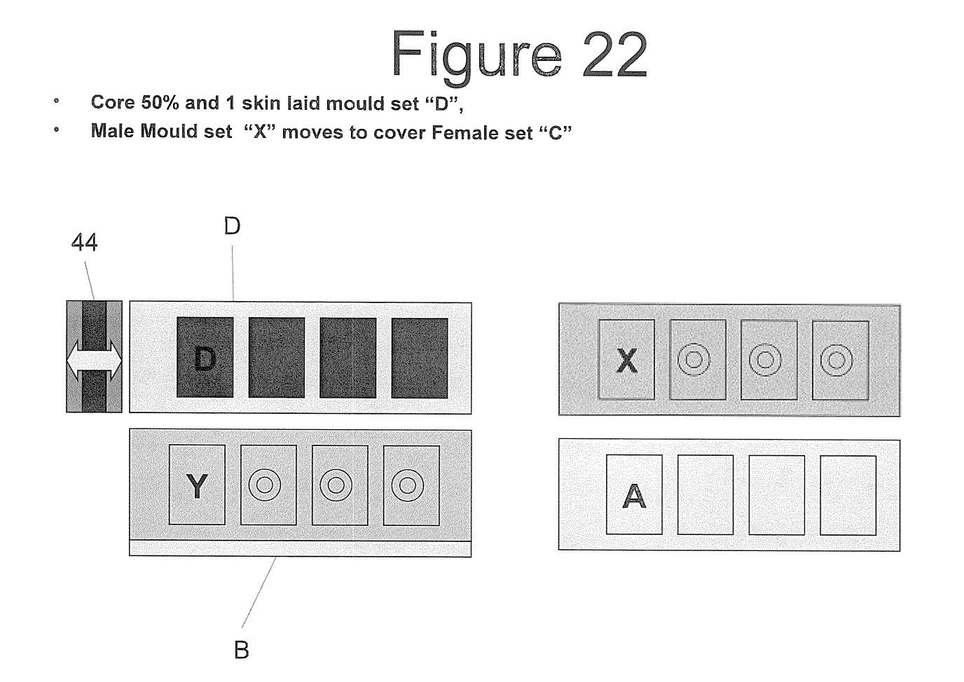

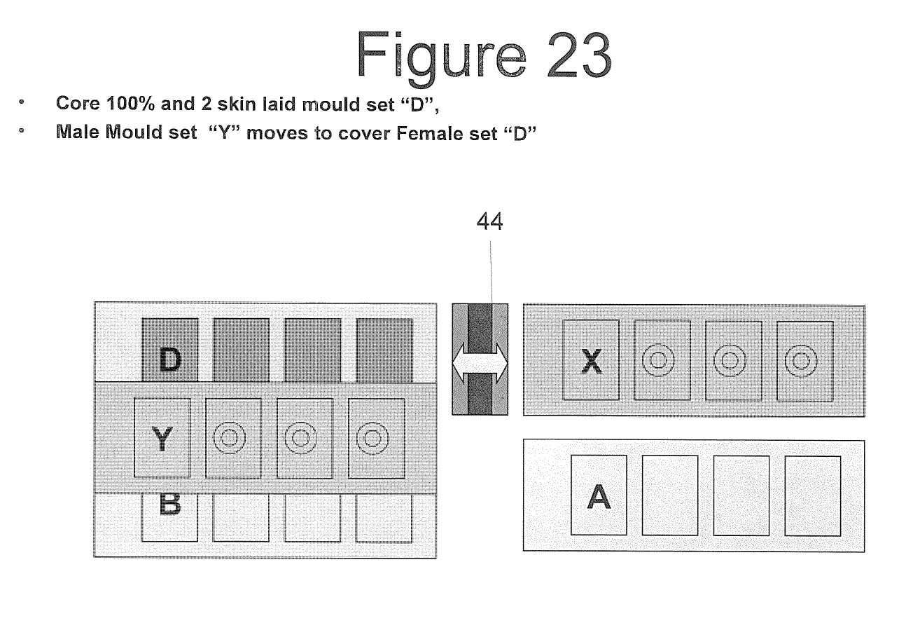

The dosing unit then continues to traverse in the same direction in FIG. 22, to lay down a first layer of fine material and 50% of the core material in mould “ID” while male mould “X” moves to cover female mould “C” and reverses direction to dispense the remaining 50% of the core material, and the second layer of fine material in mould set “D”, so that the male mould set “Y” can then be moved to cover it (FIG. 23).

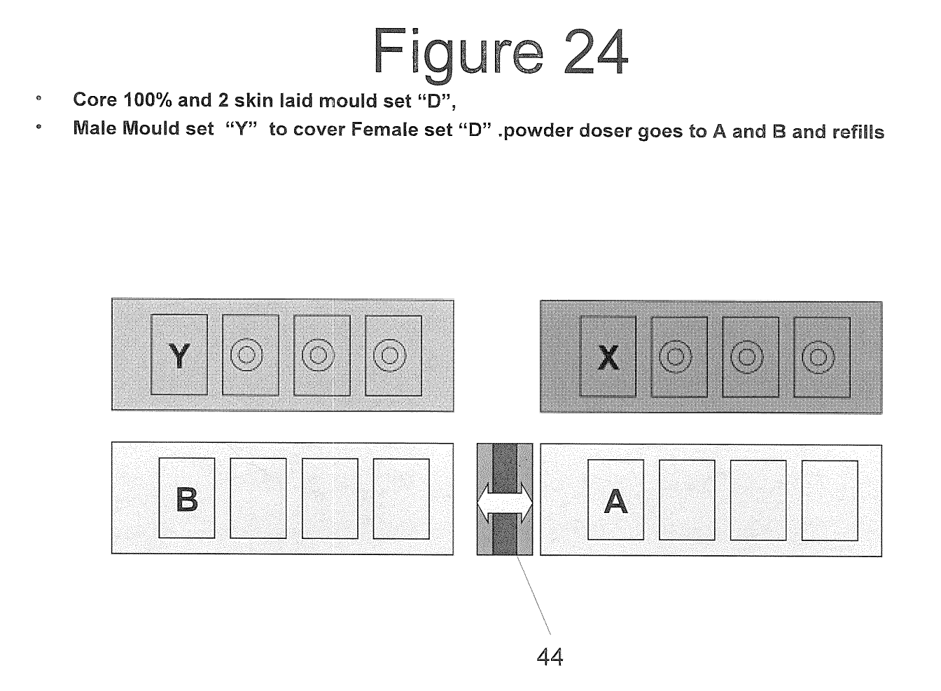

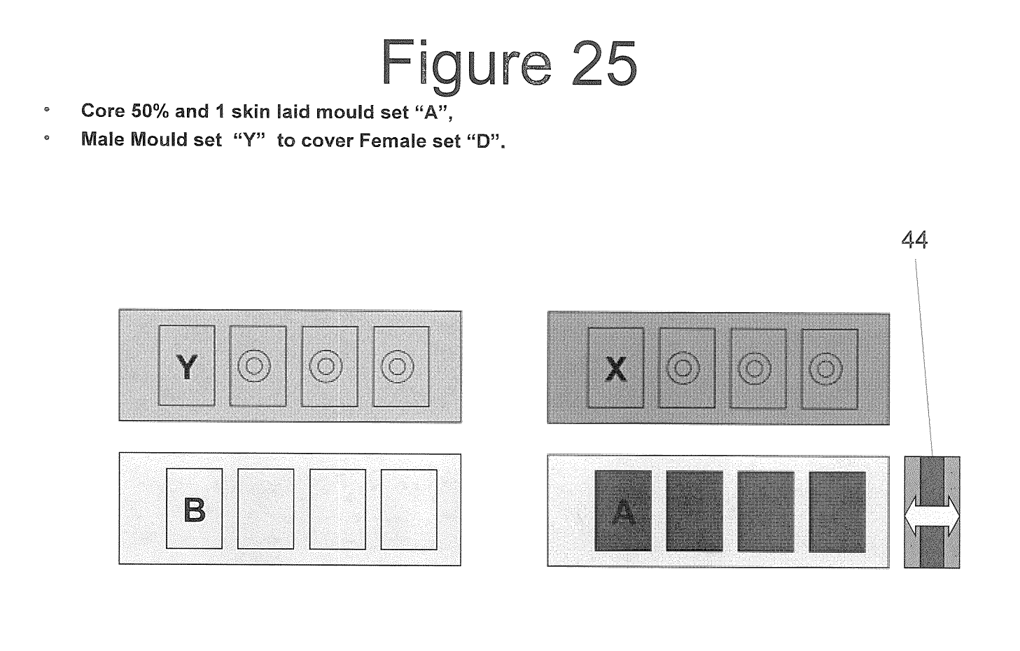

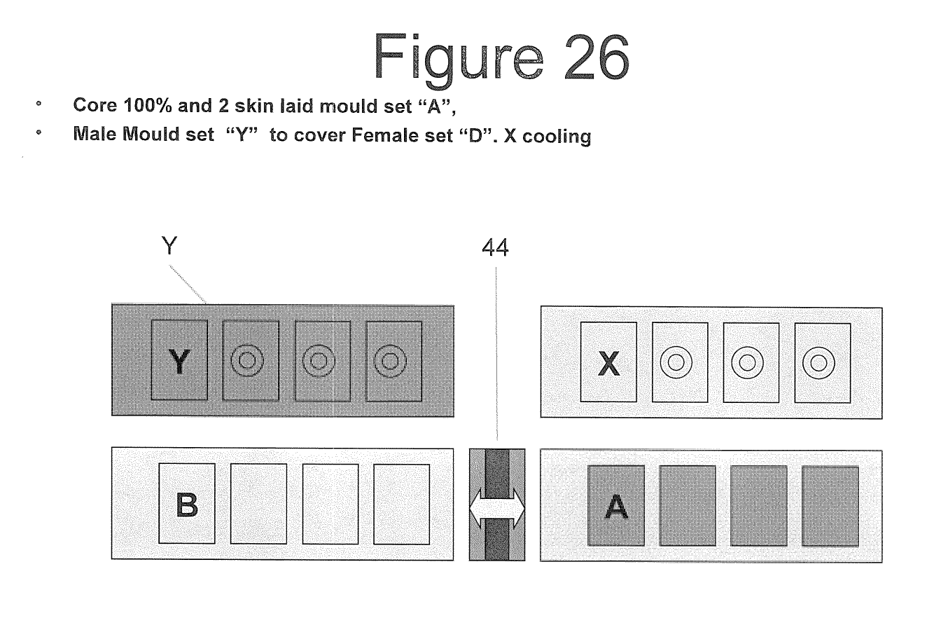

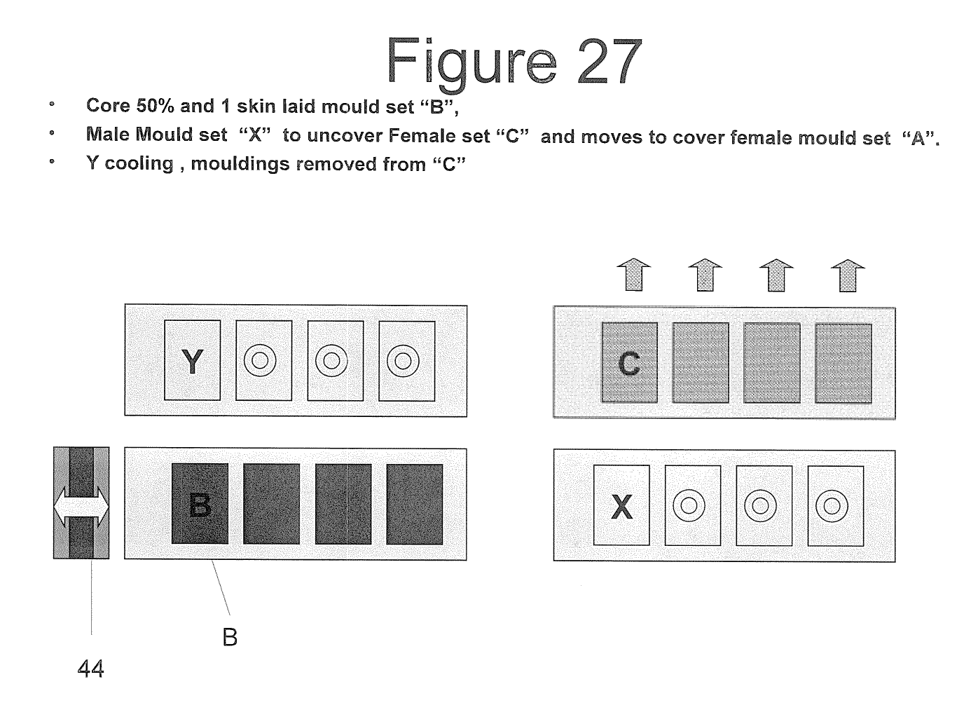

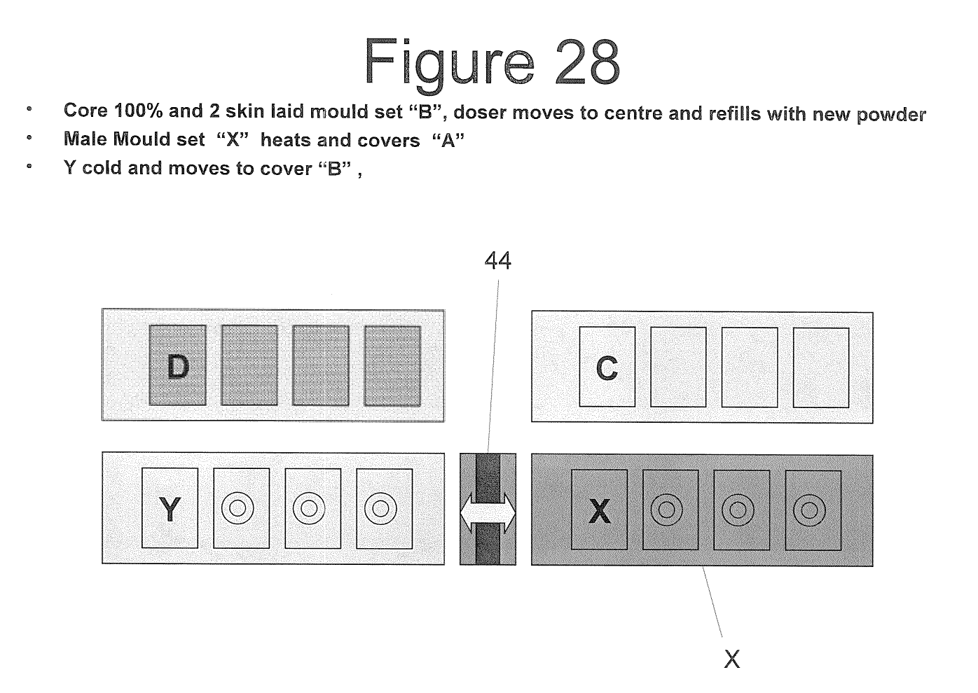

At this point the dosing unit can be moved laterally to a position between the second female mould sets “A” and “B” which are exposed by movement of the male moulds “S” and “Y” away from their mutual positions (FIG. 24). Then, in a similar sequence to that described above for filling mould sets “C” and “D” (FIGS. 19-23) the dosing unit is first traversed across mould set “A” first “outwardly” (FIG. 25) and then “inwardly” (FIG. 26) directions, and then traversed across mould set “B” “outwardly” (FIG. 27) and then “inwardly” (FIG. 28). In the meantime, starting from the position of FIG. 24, the heating cycle has been progressing for the material in moulds “C” and “D”, starting with mould “C” (FIG. 25) having heat applied by male would set “X”. In FIG. 26, male mould “X” is then cooling while heat is applied to mould “Y”, while in FIG. 27, male mould “X” has been shifted to cover female mould “A” so that completed panels can be removed from moulds “C”, while male mould set “Y” is in the cooling stage. Similarly in FIG. 28, male moulds “Y” have been shifted to cover female moulds “B” so that completed panels can be removed from female moulds “D”.

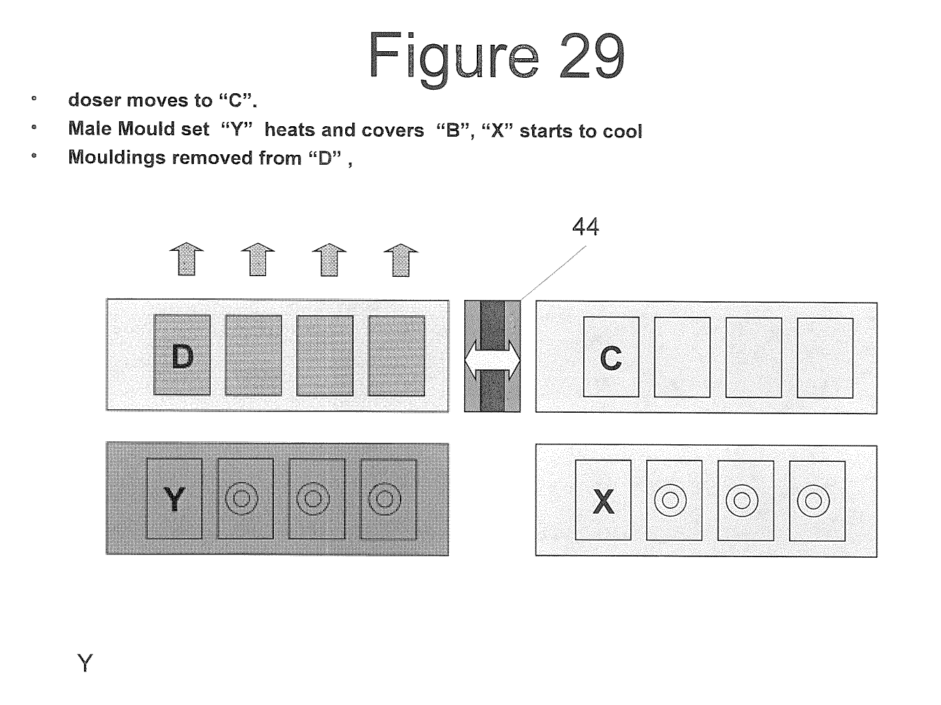

The cycle then continues as illustrated in FIGS. 29-34 in a manner which will be clear from the above description of previous stages.

Upper moulds have generally been referred to as male in the above description but both could of course be female depending on the shape to be moulded.

FIG. 35 is a diagrammatic cross-section through an exemplary powder dosing unit having three compartments 52, 54, 56 which in use carry the different powder constituents for the three layers in the process described above. As will be clear from the drawings the compartments are generally trough-shaped and each is provided with a respective dispensing roller 58, 60, 62 at its base, so that powder can be dispensed at a controlled rate. Each roller is provided in known fashion, with projections (usually pin-like) which are distributed all over its circumference, or may be arranged in a pattern to match the mould shapes, the size and spacing being arranged to suit the granularity of the powder.

It will be appreciated that although three compartments are shown, in some applications only one or two will be employed simultaneously.

Although the above description has been written the terms of a system in which the lower mould halves are held stationary and the upper mould halves are moved horizontally into positions covering them, it will of course be appreciated that it would equally be possible to arrange the system with the upper mould halves in one position and the lower mould halves movable into a position beneath them. This could have the advantage of simplifying the arrangement of the mechanisms (e.g. hydraulic/pneumatic) for providing vertical movements of the upper mould halves which might otherwise, have to be made movable in a horizontal plane as well.

Similarly, although the process has been described above with reference to shifting one or other set of moulds between different lateral positions, it will also be appreciated that an alternative possibility would be to have sets of moulds arranged on a carousel so that they could be rotated between respective stations for the various powder distribution, heating, cooling and panel removal stages of the process.

Some examples of suitable heat-mouldable materials which may be utilised in the present invention are thermoplastic materials including but not limited to polyolefins eg polyethylenes, styrenics eg polystyrene, polyesters (eg PET), thermosets eg phenolics and rubbers.

Some examples of a foaming or “blowing” agent which may be utilised are for chemical systems: exothermics, eg azodicarbonamide i.e. “Porofor” (Lanxess) or “Celogen” (Lion Copolymer), or sodium bicarbonate. Examples of endothermics are hydroxypropane tricarboxylic acid eg “Hydrocerol” (Clariant). Physical systems can include for instance nitrogen or other gases, for example a gas such as pentane may be preimpregnated in polystyrene or expanded polypropylene and then released as a gas. Alternatively nitrogen can be utilised in a system such as the “Zotefoam” nitrogen saturation process.

1. A method of moulding articles from powdered material, comprising the steps of
(a) laying down a first layer of material of a first granular fineness, in an open-topped lower mould;
(b) laying down a second layer of material of a second granular fineness, on top of the said first layer;
one of said layers including a foaming or blowing agent, and the other of said layers including heat mouldable material;
(c) applying a top closure to the mould; and
(d) heating the mould to melt and fuse the heat mouldable material while the foaming agent is activated to expand, and thereby form the article in the mould.

2. A method according to claim 1 in which the layer including the foaming agent comprises relatively coarse-grained powdered material while the other layer comprises finer-grained material.

3. A method according to claim 1 in which the step of heating the mould includes heating the top closure of the mould.

4. A method according to claim 1 in which the foaming agent is heat-activated and is triggered by the step of heating the mould.

5. A method according to claim 1 in which the foaming agent is chemically activated.

6. A method according to claim 1 in which the moulds are retracted by a predetermined distance whilst maintaining contact with the upper layer, to allow the panel to expand to a required thickness.

7. A method according to claim 1 in which the moulds can be retracted by a range of distances to allow the formation of panels of different thicknesses.

8. A method according to claim 1 wherein the finer grained material is powder is in the range of 100-3000 μm.

9. A method according to claim 1 in which the coarser grained material contains granules up to 10 mm in size.

10. A method according to claim 1 in which one or both materials include a thermoplastic such as polyethylene.

11. A method according to claim 1 in which the powders are added with the mould at least at ambient temperature and the temperature is raised after the mould has been closed.

12. A method according to claim 1 in which the moulds are also pre-heated to a temperature below 99° C.

13. A method according to claim 1 in which the temperature is raised to 150°-350° C. and held for a period of 5 to 40 minutes.

14. A method of moulding articles from powdered material in a mould comprising upper and lower halves, the method comprising the steps of:
(a) laying down a first layer of relatively fine-grained heat mouldable material in a lower mould to form a lower layer;
(b) laying down a second layer relatively coarse-grained material including a foaming or blowing agent to form a central core layer;
(c) laying down a further layer of relatively fine-grained heat mouldable material to form an upper layer;
(d) causing relative movement between the upper and lower mould halves so that the upper mould contacts the upper surface of the upper layer so as to enclose the layers of material in the mould; and
(e) applying heat to the mould so as to fuse the outer layers of material to form a skin, while the central layer is foamed so that it expands and fuses with the two outer skin layers, and the outer surfaces of the upper and lower layers are thereby moulded into close contact with the inner surfaces of the mould halves.

15. A method according to claim 14 in which the foaming agent is heat-activated and is triggered by the step of heating the mould.

16. A method according to claim 14 in which the foaming agent is chemically activated.

17. A method according to claim 14 in which the moulds are retracted by a predetermined distance whilst maintaining contact with the upper layer, to allow the panel to expand to a required thickness.

18. A method according to claim 14 in which the moulds can be retracted by a range of distances to allow the formation of panels of different thicknesses.

19. A method according to claim 14 wherein the finer grained material is powder is in the range of 100-3000 μm.

20. A method according to claim 14 in which the coarser grained material contains granules up to 10 mm in size.

21. A method according to claim 14 in which one or both materials include a thermoplastic such as polyethylene.

22. A method according to claim 14 in which the powders are added with the mould at least at ambient temperature and the temperature is raised after the mould has been closed.

23. A method according to claim 22 in which the moulds are also pre-heated to a temperature below 99° C.

24. A method according to claim 22 in which the temperature is raised to 150°-350° C. and held for a period of 5 to 40 minutes.
